(19) United States
(12) Patent Application Publication
(10) Pub. No.: US 2016/0229544 A1
(43) Pub. Date: Aug. 11, 2016

(54) ICE ACCRETION PREVENTION

(71) Applicant: AIRBUS OPERATIONS LIMITED, Bristol (GB)

(72) Inventors: Nicholas DART, Bristol (GB); James BROWN, Bristol (GB)

(73) Assignee: AIRBUS OPERATIONS LIMITED, Bristol (GB)

(21) Appl. No.: 15/022,250

(22) PCT Filed: Sep. 17, 2014
(86) PCT No.: PCT/GB2014/052808

§ 371 Date: Mar. 16, 2016

(30) Foreign Application Priority Data
Sep. 17, 2013 (GB) 1316477.7

(51) Int. Cl. B64D 15/16

(52) U.S. Cl. CPC B64D 15/16

(57) ABSTRACT

The present application proposes a device and method for controlling the size of a sheet of ice which can build up on an aircraft surface as a result of icing, particularly SLD icing. In some circumstances it is possible to tolerate a build up of some ice without significant aerodynamic penalties. However, the size of such ice sheets must be controlled to ensure that any ice sheet detaching from the aircraft surface has a mass that is within the acceptable margins for projectiles which may impact aircraft structure downstream. Thus, a first aspect of the invention provides an aircraft having an exterior surface arranged to face upstream in the airflow direction during flight and a plurality of anti-ice accretion projections extending away from the exterior surface. Each anti-ice accretion projection has a leading edge facing upstream in the airflow direction and a trailing edge facing downstream of the airflow direction, wherein the trailing edge provides an aerodynamic step extending substantially perpendicular to the airflow over the exterior surface. The step is arranged to: create a shadow region immediately downstream of the projection where water droplets carried in the airflow cannot impinge on the exterior surface; and/or create a region of separated flow over the exterior surface immediately downstream of the projection.

### FIELD OF THE INVENTION

The present invention relates to a device and method for preventing the accretion of large sheets of ice on airstream-facing exterior surfaces of an aircraft, particularly the ice accretion caused by super-cooled large droplets (SLD) of water.

### BACKGROUND OF THE INVENTION

Ice formations on aircraft external surfaces are of great interest in the aerospace industry. Ice accretion can distort the aerodynamic surface profile, modifying the aircraft performance and handling characteristics. De-icing systems are commonly found on aircraft forward-facing edges, such as fixed wing leading edges, rotary wings, fixed horizontal and vertical tailplane leading edges, nose cones, etc. These typically comprise a flexible element and/or a heat source to dislodge the ice accretion.

Aircraft certification, e.g. as defined by FAR/CS 25 Appendix C, has previously only accounted for an icing envelope characterised by water droplets with mean diameters of up to 50 microns, sometimes referred to as “cloud droplets”. Recent aircraft accidents, in particular the loss of American Eagle Flight 4184, have highlighted the dangers of super-cooled large droplets (SLD) which may be defined as having a droplet spectrum where a significant part of the distribution, typically about 30%, has a diameter greater than 50 microns. SLD are considered to include “freezing drizzle” (a significant part of the distribution having droplet diameters of 100-500 microns) and “freezing rain” (a significant part of the distribution having droplet diameters greater than 500 microns, up to around 2500 microns). Whilst rare, SLD icing tends to create ice accretion over a wider area of the aircraft's surface, often beyond that commonly protected by de-icing systems. In the American Eagle Flight 4184 accident a ridge of ice behind the de-icing boot caused a region of separated flow resulting in an extreme uncontrolled aileron deflection.

In view of the issues discussed above, forthcoming aircraft certification changes will extend the icing envelope to account for SLD icing conditions. It is thought that certification will be based largely on simulated, i.e. predicted, ice formation as the rare SLD conditions are currently believed to be too difficult to incorporate into a test-based certification program.

The new regulations will bring many challenges for airframe design to meet the new certification and operational criteria. For example, exterior surfaces of the aircraft not previously requiring anti-icing or de-icing systems for certification may need ice protection for SLD icing. Extending the effective area of existing anti-icing or de-icing systems to the wider area to accommodate SLD icing may not be technically feasible or cost-effective. Alternative solutions to the problems of SLD icing are therefore required.

### SUMMARY OF THE INVENTION

The present inventors propose a device and method for controlling the size of a sheet of ice which can build up on an aircraft surface as a result of icing, particularly SLD icing. In some circumstances it is possible to tolerate a build up of some ice without significant aerodynamic penalties. However, the size of such ice sheets must be controlled to ensure that any ice sheet detaching from the aircraft surface has a mass that is within the acceptable margins for projectiles which may impact aircraft structure downstream.

Thus, a first aspect of the invention provides an aircraft having an exterior surface arranged to face upstream in the airflow direction during flight and a plurality of anti-ice accretion projections extending away from the exterior surface, each anti-ice accretion projection having a leading edge facing upstream in the airflow direction and a trailing edge facing downstream of the airflow direction, wherein the trailing edge provides an aerodynamic step extending substantially perpendicular to the airflow over the exterior surface, the step being arranged to: create a shadow region immediately downstream of the step where water droplets carried in the airflow cannot impinge on the exterior surface; and/or create a region of separated flow over the exterior surface immediately downstream of the step.

By creating a shadow region in which water droplets are prevented from impinging on the exterior surface, ice cannot accumulate in that shadow region. Thus, the shadow region can define the maximum extent of an ice sheet and/or create a break between neighbouring ice sheets.

The term impinge is used in the sense of its normal technical usage, to mean the initial contact between a water droplet carried by an airflow and the exterior surface over which that air flow is travelling. That is, impingement is direct contact between airborne water droplet and exterior surface, not indirect contact following a ricochet of the water droplet off other structure, or water runoff, for example. Thus, the shadow region is a region in which such contact is prevented because this region is shielded from the air flow by the step.

By creating a region of separated flow over the exterior surface, water run-back caused by e.g. SLD icing in warm atmospheric conditions can be dispersed into the air flow. That is, the separated flow causes any water running over the exterior surface in the downstream direction towards the step of the projection to be lifted away from the exterior surface and thereby dispersed into the fast-flowing air travelling over the exterior surface.

The aircraft includes a plurality of anti-ice accretion projections. Thus, any accreted ice may be divided by the plurality of projections into a plurality of acceptably small ice sheets.

It may be desirable for the step to be arranged to create both the shadow region and the region of separated flow. In this way, the step can provide a break in accreted ice caused by both direct impingement of water droplets and by water run-back in mild conditions.

In all of the described aspects of the invention each step extends substantially perpendicular to the airflow over the exterior surface, i.e. transverse to the local airflow. This arrangement provides an effective shadow region and/or region of separated flow, and also enables the extent of any accumulated ice to be limited to a particular position within the airflow.

Each projection may be integrated into a boundary between exterior panels of the aircraft. That is, of a pair of exterior panels having a boundary between them that runs transverse to the air flow, the trailing face of the forward-most panel may have a greater height than the leading face of the aft-most panel, the region of the trailing face of the forward-most panel which projects beyond the leading face of the aft-most panel providing the aerodynamic step.

The exterior surface is typically a surface of a fixed airframe structure, rather than a movable surface.

A second aspect of the present invention provides an aircraft having an exterior surface arranged to face upstream in the airflow direction during flight, the exterior surface having a super-cooled large droplet (SLD) impingement region within which super-cooled large droplets (SLD) of water can (or are predicted to) impinge on the exterior surface, and a plurality of anti-ice accretion projections extending away from the exterior surface from within the SLD impingement region, each anti-ice accretion projection having a leading edge facing upstream in the airflow direction and a trailing edge facing downstream in the airflow direction, wherein the trailing edge provides an aerodynamic step extending substantially perpendicular to the airflow direction and the step is arranged to create a shadow region immediately downstream of the step where water droplets cannot impinge on the exterior surface.

The term super-cooled large droplets (SLD) is used herein in the sense of its normal technical meaning, as is well known in the art. In prior art aircraft SLD can cause unacceptably large accumulations of ice, in part because the large droplets travel via relatively straight trajectories rather than following the streamlines of the air flow, thus creating a large impingement zone. The shadow region of the second aspect provides a region in which ice cannot accumulate because there are no impinging water droplets to freeze, and thus serves to define the maximum extent of an ice sheet and/or create a break between neighbouring ice sheets.

In certain conditions, particularly when the total temperature is in the region of 0 degrees centigrade, SLD can result in water run-back from the SLD impingement site. The run-back water travels downstream from the impingement site before it freezes, thus causing large ice sheets. The region of separated air flow of the third aspect causes such run-back water to be dispersed into the air flow. That is, the separated flow causes any water running over the exterior surface in the downstream direction towards the step of the projection to be lifted away from the exterior surface and thereby dispersed into the fast-flowing air travelling over the exterior surface.

Total temperature is the temperature that the air reaches at the stagnation point on an aircraft, i.e. the position on the exterior surface at which the air velocity is zero. Mathematically, the total temperature is the static temperature (also called the ambient temperature or outside air temperature) plus V²/2010, where V is the true air speed in metres per second. For example, at an air speed of 100 m/s the total temperature is approximately 5 degrees centigrade warmer than the static temperature. Total temperature is typically used to determine the conditions for ice formation because the icing threshold depends not only on the static temperature, but also on aircraft speed and the kinetic heading that is generated through that speed. Total temperature incorporates this kinetic heading effect.

The step of the second aspect is preferably arranged to also create a region of separated flow over the exterior surface immediately downstream of the step.

A third aspect of the invention provides an aircraft having an exterior surface arranged to face upstream in the airflow direction during flight, the exterior surface having a water run-back region within which impinged water droplets can flow over the exterior surface, and a plurality of anti-ice accretion projections extending away from the exterior surface from within the water run-back region, each anti-ice accretion projection having a leading edge facing upstream in the airflow direction and a trailing edge facing downstream in the airflow direction, wherein the trailing edge provides an aerodynamic step extending substantially perpendicular to the airflow direction and the step is arranged to create a region of separated air flow over the exterior surface immediately downstream of the step for dispersing water droplets flowing over the exterior surface.

The step of the third aspect is preferably arranged to also create a shadow region immediately downstream of the step within which water droplets (e.g. SLD) cannot impinge on the exterior surface.

The exterior surface preferably has a water droplet impingement region within which droplets of water carried in the airflow having a mean diameter of 50 microns or less are predicted to impinge on the exterior surface, and the anti-ice accretion projection is preferably outside of, i.e. not within, the water droplet impingement region. That is, the projection may be provided outside of sites where normal ice accumulation occurs, and where alternative de-icing protection is typically provided.

Each step preferably has a height of 3 mm or more above the exterior surface, and preferably 5 mm or more. The maximum height of the step will probably be determined by the calculated drag penalty, but a typical maximum threshold may be 100 mm or less, preferably 20 mm or less.

Preferably each projection has a pair of sides which extend from the trailing edge to the leading edge, and the pair of sides are spaced apart from each other at the trailing edge by a distance of 25 mm or more. This provides a sufficiently long trailing edge to have a significant effect.

A fourth aspect provides an aircraft having an exterior surface arranged to face upstream in the airflow direction during flight and a plurality of anti-ice accretion projections extending away from the exterior surface, each anti-ice accretion projection having a leading edge facing upstream in the airflow direction and a trailing edge facing downstream of the airflow direction, wherein the trailing edge provides an aerodynamic step extending substantially perpendicular to the airflow over the exterior surface, the step having a height of 3 mm or more above the exterior surface.

Thus, the step is significantly larger than a typical panel to panel step caused by manufacturing tolerances. The step height is preferably 5 mm or more.

The exterior surface is preferably not protected by an ice protection system arranged to dislodge ice accumulated within an ice protection zone of the exterior surface.

Thus, the present invention may be used in areas of the aircraft where typical de-icing measures are not necessary, but where protection against SLD icing is required.

Where the present invention is deployed on an exterior surface that does have an ice protection system, the projection is preferably located downstream of the ice protection zone. In this way, the projection can prevent excessive ice accumulation in downstream areas not protected by the ice protection system, especially during SLD icing events.

Preferably, an intersection between the trailing edge step of the anti-ice accretion projection and the exterior surface downstream of the projection forms an angle of 150 degrees or less, and preferably 135 degrees or less. The steepness of this angle may be critical for ensuring that the shadow region and/or flow separation region is created.

The anti-ice accretion projection is preferably not heated, e.g. by a heater mat or similar. Thus, the projection is a passive device which is simple to maintain and is unlikely to fail.

The anti-ice accretion projection may be not moveable with respect to the exterior surface. In some embodiments each anti-ice accretion projection is movable between an extended position in which the trailing edge provides the aerodynamic step and a retracted position in which the trailing edge is substantially flush with the exterior surface. The movement may be in response to a change in flight conditions. For example, the projection may be deployed during take-off, holding conditions, diversions and/or landing (i.e. flight below about 31,000 feet or 9,450 metres), when ice accumulation is possible, and retracted during high altitude cruise (i.e. flight above about 31,000 feet or 9,450 metres), when ice accumulation is unlikely and parasitic drag from the projection is particularly undesirable.

Each anti-ice accretion projection preferably has a ramp configuration. The anti-ice accretion projection may have an aerodynamic surface extending between the leading edge and the trailing edge, the distance between the aerodynamic surface and the exterior surface increasing continuously from the leading edge to the trailing edge. This shape may reduce parasitic drag caused by the projection.

The plurality of projections may be spaced apart from one another in the airflow direction, or in a direction substantially perpendicular to the airflow direction.

In some embodiments there may be one or more projections within the SLD impingement zone to create one or more shadow regions, and one or more other projections downstream of the SLD impingement zone to create one or more regions of separated flow.

Optionally the projections have a rectangular planform shape, each projection having a pair of sides which run parallel with each other as they extend from the trailing edge to the leading edge. Alternatively each projection has a pair of sides which become progressively closer to each other as they extend from the trailing edge to the leading edge. This tapered shape is preferred because it enables the sides to divert water droplets away from the shadow region or the region of separated flow.

Preferably there are channels between the projections, and the projections are arranged so that water droplets are driven by the airflow through the channels between the projections during flight of the aircraft. Preferably each projection is arranged to divert the water droplets into the channels between the projections.

Each projection may have any suitable planform shape or aspect ratio, preferable examples including a rectangular or triangular planform shape.

The exterior surface preferably comprises an exterior surface of a nose cone, fuselage, wing, vertical tail plane, or horizontal tail plane of the aircraft. In the case of a wing, vertical tail plane or horizontal tail plane or other aircraft structure with a leading edge and a trailing edge, then typically the projections are located closer to the leading edge than the trailing edge.

A fifth aspect of the invention provides a method of preventing ice accretion on an exterior surface of an aircraft facing upstream in the airflow direction during flight, the method including the steps of: providing a plurality of anti-ice accretion projection extending away from the exterior surface; and: creating a shadow region immediately downstream of each projection where water droplets carried in the airflow cannot impinge on the exterior surface; and/or creating a region of separated flow over the exterior surface immediately downstream of each projection where water droplets flowing over the exterior surface are dispersed into the airflow.

The projections may have any of the features of the anti-ice accretion projections discussed above in relation to the first, second, third or fourth aspects.

Optionally, in step (a) the anti-ice accretion projections may be provided within a super-cooled large droplet (SLD) impingement region within which super-cooled large droplets (SLD) of water can impinge on the exterior surface, and step (b) may be carried out.

Alternatively or in addition, in step (a) the anti-ice accretion projections may be provided within a water run-back region within which impinged water droplets (preferably SLD) can flow over the exterior surface, and step (c) may be carried out.

The method may include the step of retracting the anti-ice accretion projections during cruise conditions so that they are substantially flush with the exterior surface.

Step (a) may include providing an anti-ice accretion projection having a leading edge facing upstream in the airflow direction and a trailing edge facing downstream of the airflow direction, the trailing edge providing an aerodynamic step extending substantially perpendicular to the airflow over the exterior surface, and the step creating the shadow region and/or region of separated flow.

Any of the optional, or preferred, features described above may be applied to any of the aspects of the invention, either alone or in any combination.

### BRIEF DESCRIPTION OF THE DRAWINGS

Embodiments of the invention will now be described with reference to the accompanying drawings, in which:

FIGS. 1 (a) and (b) illustrate the possible ice accretion on a prior art aircraft nose cone as a result of SLD icing, FIG. 1(a) showing the nose cone before ice accretion and FIG. 1(b) showing it after an SLD icing event;

FIG. 2 is a schematic drawing of an ice accretion prevention device according to a comparative example, including an expanded detail view;

FIG. 3 is a schematic drawing showing the ice accretion prevention device of FIG. 2 after an SLD icing encounter, including an expanded detail view;

FIG. 4 is a cross-sectional viewing showing an alternative ice accretion prevention device;

FIG. 5a shows an aircraft according to a first embodiment of the invention;

FIG. 5b is a schematic drawing of the nose cone of the aircraft of FIG. 5a;

FIG. 6 is a side view of one of the projections;

FIG. 7 is a plan view of part of a wing of an aircraft according to a second embodiment of the invention; and

FIG. 8 is a plan view of part of a wing of an aircraft according to a third embodiment of the invention.

### DETAILED DESCRIPTION OF EMBODIMENT(S)

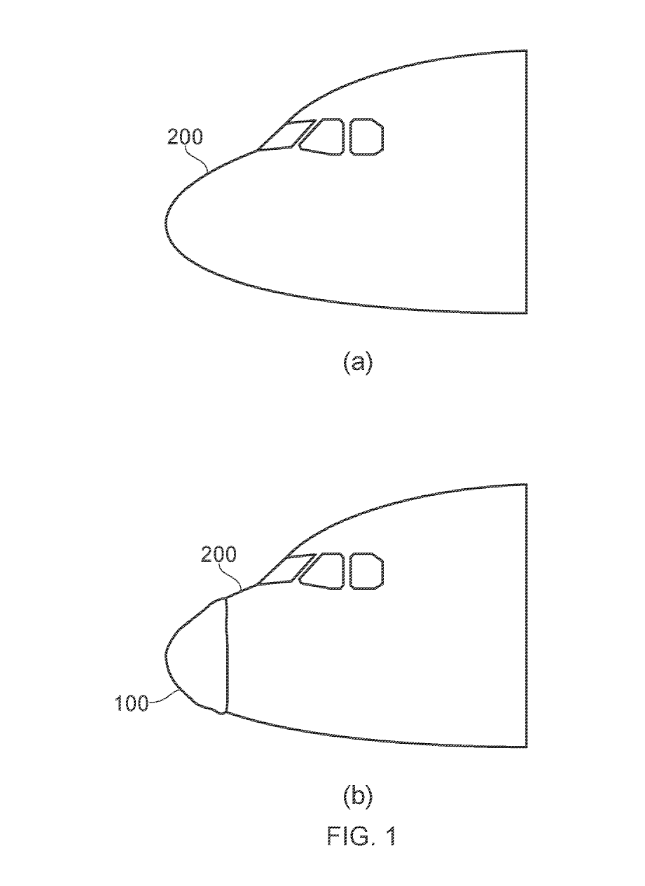

FIGS. 1 (a) and (b) illustrate the possible build up of ice 100 on an exterior surface 200 of the nose cone of a prior art aircraft as a result of an SLD icing event. In this embodiment the exterior surface 200 comprises a radome of the nose cone.

During normal flight conditions, when the mean diameter of water droplets carried in the air flow is less than 50 microns, the size of the accumulated ice sheet may be tolerable. That is, the parasitic drag (and lift loss in the case of an aerodynamic lifting surface such as a wing) associated with the ice may be within acceptable margins, and the ice sheet may have a sufficiently low mass that no critical damage will be sustained to downstream aircraft structure if it were to detach in one piece from the nose cone. However, in conditions where super-cooled large droplets (SLD) are present, the ice sheet may be much larger. The present embodiment is concerned with ensuring that such an ice sheet is not able to detach in one piece, since its mass would be outside of acceptable margins for projectiles which may impact the aircraft structure (wing leading edge, empennage etc) downstream of the nose cone. It is also concerned with limiting the size of any accumulated ice sheet during SLD impingement.

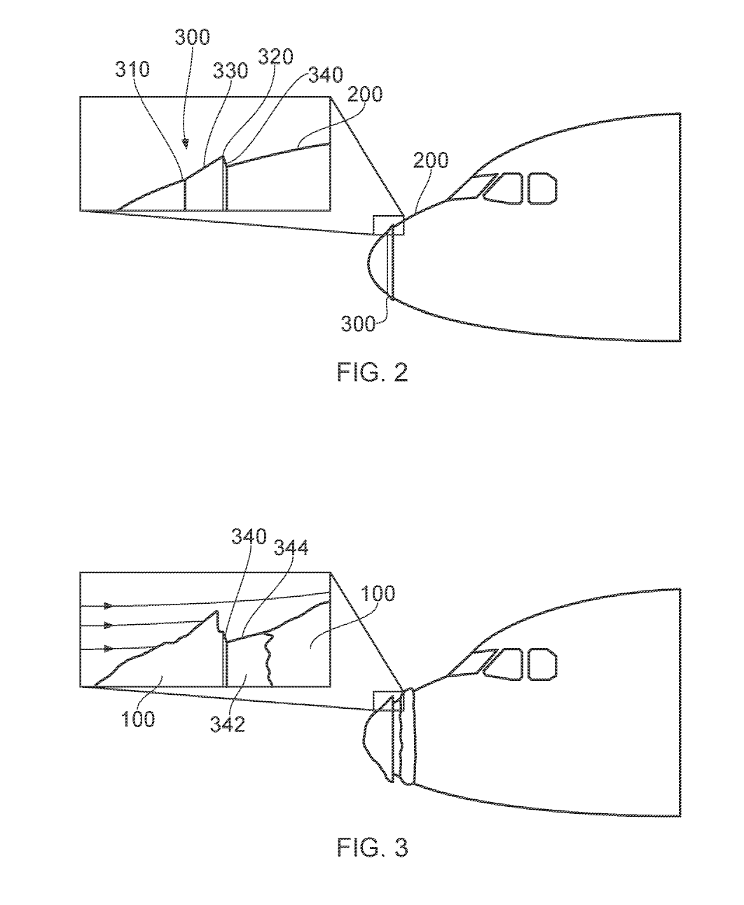

FIGS. 2 and 3 illustrate a comparative example, not according to the invention. A ramped projection 300 extends around a circumference of the nose cone exterior surface 200 so that it is generally ring-shaped. The projection 300 has a leading edge 310, a trailing edge 320, and an aerodynamic surface 330 extending therebetween. The projection 300 is arranged with respect to the exterior surface 200 so that the trailing edge 320 is substantially perpendicular to the direction of airflow over the exterior surface 200.

The leading edge 310 is substantially flush with the exterior surface 200, while the trailing edge 320 is offset from the exterior surface 200 so that there is an aerodynamic step 340 between the trailing edge and the exterior surface. The step 340 has a height of approximately 5 mm, although steps of between 3 mm and 100 mm, preferably 20 mm or less, may be acceptable. A typical acceptable tolerance for a step on an aircraft surface, e.g. between neighbouring skin panels, is 2 mm or less, usually substantially less than this in regions where parasitic drag must be carefully controlled. Thus, the step 340 represents a departure from the typical design of an aircraft fixed surface.

An SLD impingement region is defined as the region within which SLD are predicted to impinge (i.e. directly impact) on the exterior surface. The SLD impingement region is larger than a water droplet impingement region defined as the region within which water droplets having a mean diameter of less than 50 microns will impinge on the exterior surface. This is because small water droplets typically follow a trajectory that follows the streamlines, while larger water droplets are less influenced by the airflow and tend to have straighter trajectories. Ice may accumulate within or downstream of the SLD impingement region because of a phenomenon known as water run-back, which occurs when there is SLD impingement in relatively warm atmospheric conditions (typically where the total temperature is around 0 degrees centigrade). In such conditions water droplets run along the exterior surface before freezing further downstream. Thus, the ice sheet that accumulates in the absence of any countermeasures (as shown in FIG. 1 (b)) typically covers a larger expanse of the exterior surface 200 than the SLD impingement region.

In this embodiment the projection 300 is located within the SLD impingement region so that the step 340 has the effect of providing a “shadow region” 342 in the exterior surface immediately downstream of the projection 300. That is, the step 340 provides a barrier preventing water droplets carried in the air flow from impinging on the exterior surface in the shadow region 342. Since water droplets are prevented from impinging on the shadow region 342, ice cannot accumulate in this region, and the shadow region 342 thus provides a break between sheets of ice upstream of the projection and downstream of the projection.

The step 340 also provides a localised flow separation region 344 immediately downstream of the step 340 which causes the air flow in this region to become separated so that run-back water flowing over the exterior surface 200 is drawn away from the exterior surface 200 and carried away by the air flow. Thus, in warm conditions (where the total temperature is around 0 degrees centigrade) the run-back water caused by SLD impingement is dispersed so that it cannot freeze on the exterior surface.

The projection 300 thus prevents the accumulation of large ice sheets as a result of both SLD impingement and water runback caused by SLD impingement in warm conditions.

The step 340 is at an angle of approximately 90 degrees to the exterior surface 200. It is important that this angle is sufficiently steep (a maximum of about 150 degrees, preferably 135 degrees or less, is considered acceptable, with a minimum of about 10 degrees) to create the shadow region 342 or localised flow separation region 344.

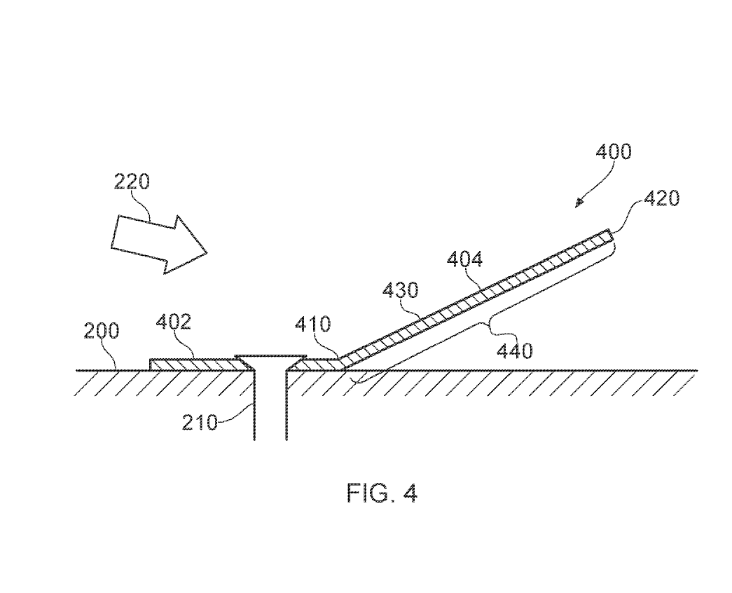

FIG. 4 shows an alternative ramped projection 400 formed by an elongate sheet of material which is bent longitudinally to form an attachment portion 402 and a ramp portion 404. The projection 400 extends around the nose cone of an aircraft in a direction substantially perpendicular to the direction of air flow, in the same way as the arrangement of FIGS. 2 and 3. The attachment portion 402 is seated on the aircraft exterior surface 200 and attached thereto by fasteners 210. The ramp portion 204 projects away from the exterior surface 200, so that an aerodynamic surface 430 thereof extends from a leading edge 410 at the intersection with the attachment portion to a trailing edge 420 which extends substantially perpendicular to the direction of airflow (indicated by arrow 220) over the exterior surface 200. The trailing edge 420 is thus suspended above the exterior surface 200 to provide an aerodynamic step 440.

Although the step 440 is at an acute angle to the exterior surface 200, unlike the closed step 320 of FIGS. 2 and 3 which is approximately perpendicular to the surface 200, its effect is the same. That is, it provides a shadow region within which SLD droplets cannot impinge on the exterior surface 200, and it provides a localised flow separation region which causes run-back water to detach from the exterior surface 200 and be carried away by the air flow. The shadow region provided by the projection 400 can be considerably wider than that of the projection 500, since it can include the region of the exterior surface which is sheltered directly beneath the ramp portion 204, i.e. upstream of the trailing edge 420.

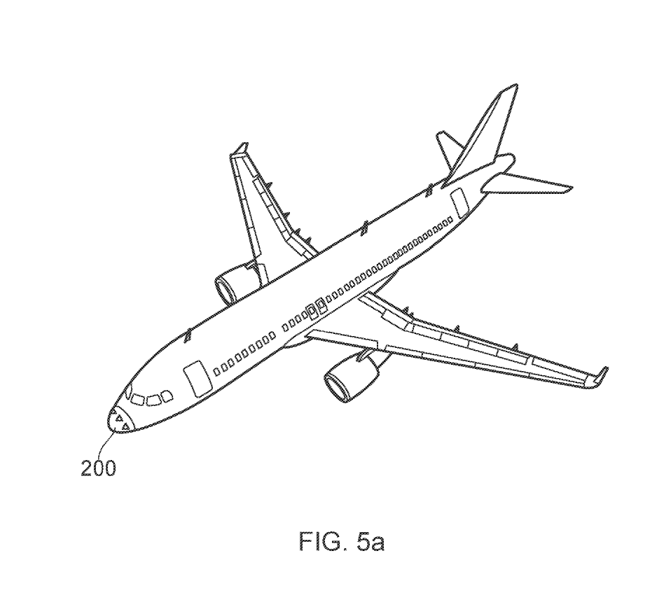

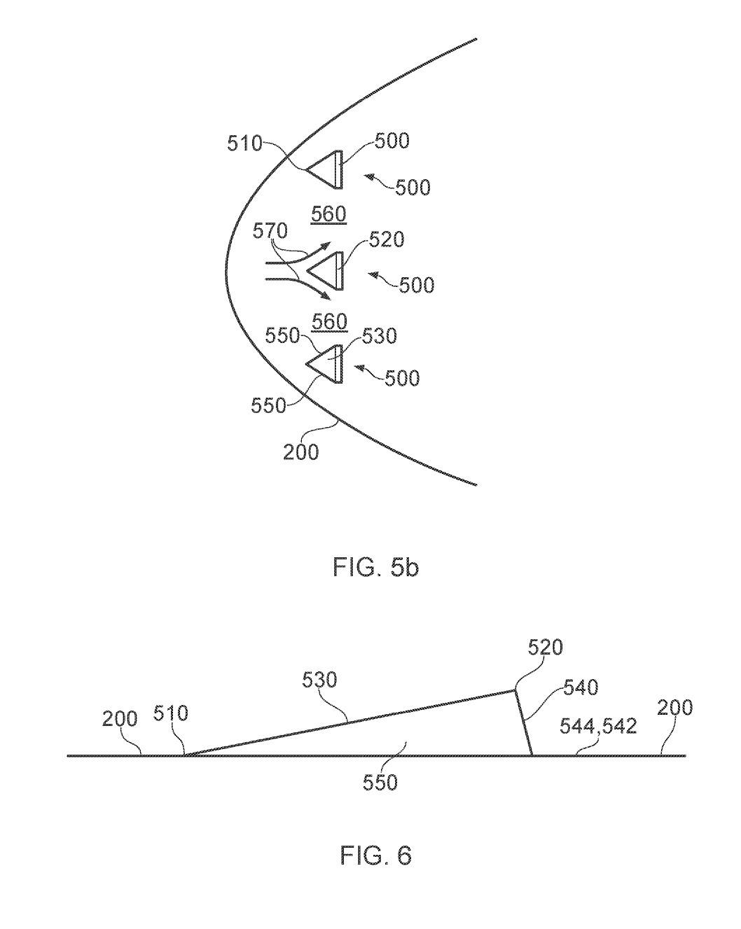

FIG. 5a shows an aircraft according to an embodiment of the invention. The aircraft has a nose cone with an exterior surface 200 shown in detail in FIG. 5b. As illustrated in FIGS. 5b and 6, a plurality of ramped projections 500 are spaced apart around a circumference of the nose cone exterior surface 200. Each projection 500 has a leading edge 510, a trailing edge 520, and an aerodynamic surface 530 extending therebetween. Each projection 500 is arranged with respect to the exterior surface 200 so that the trailing edge 520 is substantially perpendicular to the direction of local airflow over the exterior surface 200.

The leading edge 510 of each projection is substantially flush with the exterior surface 200, while the trailing edge 520 is offset from the exterior surface 200 so that there is an aerodynamic step 540 between the trailing edge and the exterior surface. The step 540 has a height of approximately 5 mm, although steps of between 3 mm and 100 mm, preferably 20 mm or less, may be acceptable.

Each projection 500 is located within the SLD impingement region so that each projection 500 provides a similar effect to the projections 300, 400 described above.

That is, each step 540 has the effect of providing a “shadow region” 542 in the exterior surface immediately downstream of the projection 500, providing a barrier preventing water droplets carried in the air flow from impinging on the exterior surface in the shadow region 542. Since water droplets are prevented from impinging on the shadow regions 542, ice cannot accumulate in these regions.

Each step 540 also provides a localised flow separation region 544 immediately downstream of the step 540 which causes the air flow in this region to become separated so that run-back water flowing over the exterior surface 200 is drawn away from the exterior surface 200 and carried away by the air flow. Thus, in warm conditions (where the total temperature is around 0 degrees centigrade) the run-back water caused by SLD impingement is dispersed so that it cannot freeze on the exterior surface.

Each projection 500 thus prevents the accumulation of large ice sheets as a result of both SLD impingement and water runback caused by SLD impingement in warm conditions.

The projections 500 are spaced apart to enable the airflow over the exterior surface to flow through channels 560 between them. Thus accreted ice may be divided by the plurality of projections into a plurality of acceptably small ice sheets, each ice sheet occupying a respective one of the channels 560.

The step 540 is at an angle of approximately 90 degrees to the exterior surface 200. It is important that this angle is sufficiently steep (a maximum of about 150 degrees, preferably 135 degrees or less, is considered acceptable, with a minimum of about 10 degrees) to create the shadow region 542 or localised flow separation region 544.

Each projection 500 has a triangular planform shape as shown in FIG. 5b with a pair of sides 550 which become progressively closer to each other as they extend from the trailing edge 520 (where the distance between them is at a maximum) to the leading edge 510 where they meet at a point. This tapered shape causes water droplets driven by the surface airflow to be diverted by the sides 550 of the projections as indicated by arrows 570 into the channels 560 between the projections 500 and away from the shadow region 542.

The trailing edge 520 has a spanwise width of 25 mm or more. In other words, the pair of sides 550 are spaced apart from each other at the trailing edge 520 by a distance of 25 mm or more. This provides a sufficiently long trailing edge 520 to have a significant effect. Note that the number of projections 500 shown in FIG. 5b is indicative only, and optionally a larger number of projections may be provided.

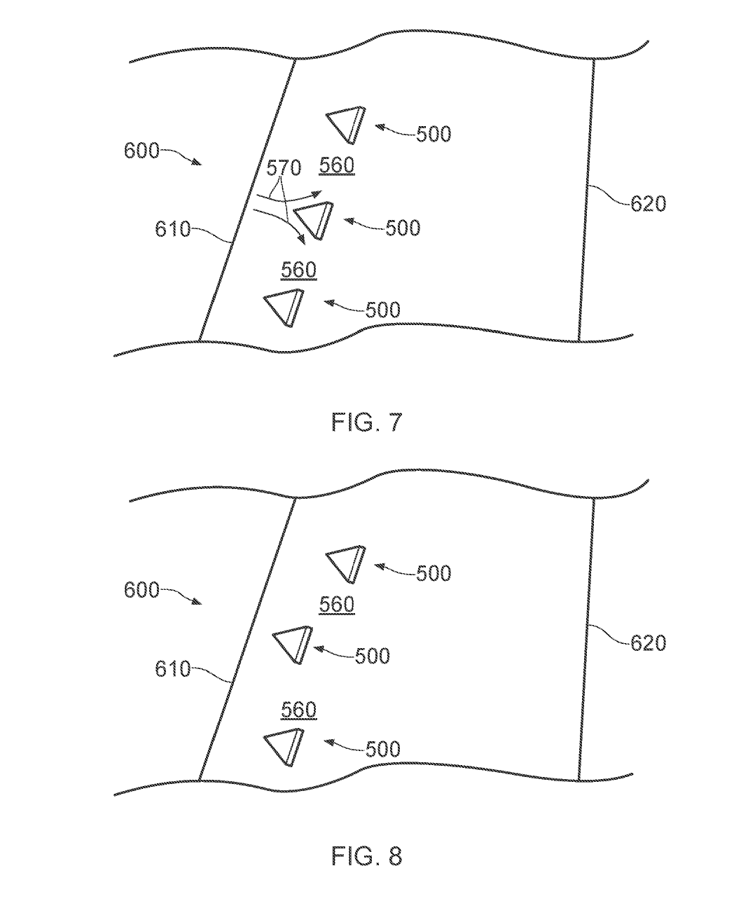

Optionally a wing of the aircraft of FIG. 5a may also be provided with projections as shown in FIG. 7. The wing has a leading edge 610 and trailing edge 620. A plurality of projections 500 are arranged on the upper exterior surface of the wing, spaced apart in a span-wise direction. Each projection 500 in FIG. 7 is identical to the projections 500 shown in FIGS. 5b and 6 so will not be described again. The local airflow over the upper exterior surface of the wing is approximately perpendicular to the leading edge 610, so the trailing edges 520 of the projections are arranged substantially parallel with the leading edge 610 of the wing.

The projections 500 in FIGS. 5b and 7 are spaced apart in a direction parallel to the leading edge 610 and substantially perpendicular to the airflow direction, but optionally they may be arranged in an offset manner as shown in FIG. 8, i.e. spaced apart from one another in the airflow direction as well as in a direction substantially perpendicular to the airflow direction. In both cases the projections 500 are arranged so that water droplets are driven by the local airflow through the channels 560 between the projections.

The nose cone of FIG. 5b and the wing of FIGS. 7 and 8 do not have any alternative ice protection systems, but in other embodiments in which the exterior surface does incorporate an ice protection system such as an electro-thermal heater mat or flexible element to dislodge any accumulated ice, the projections 500 will preferably be located downstream of the zone protected by the ice protection system.

The projections 500 in the embodiments of FIGS. 5-8 are all in the form of thickened skin regions (like the projection 300 of FIG. 2) but optionally some or all of the projections 500 may be replaced by projections 400 of the kind shown in FIG. 4.

Although the invention has been described above with reference to one or more preferred embodiments, it will be appreciated that various changes or modifications may be made without departing from the scope of the invention as defined in the appended claims.

1. An aircraft having an exterior surface arranged to face upstream in the airflow direction during flight and a plurality of anti-ice accretion projections extending away from the exterior surface, each anti-ice accretion projection having a leading edge facing upstream in the airflow direction and a trailing edge facing downstream of the airflow direction, wherein the trailing edge provides an aerodynamic step extending substantially perpendicular to the airflow over the exterior surface, the step being arranged to:
a) create a shadow region immediately downstream of the projection where water droplets carried in the airflow cannot impinge on the exterior surface; and/or
b) create a region of separated flow over the exterior surface immediately downstream of the projection.

2. An aircraft having an exterior surface arranged to face upstream in the airflow direction during flight, the exterior surface having a super-cooled large droplet (SLD) impingement region within which super-cooled large droplets (SLD) of water can impinge on the exterior surface, and a plurality of anti-ice accretion projections extending away from the exterior surface from within the SLD impingement region, each anti-ice accretion projection having a leading edge facing upstream in the airflow direction and a trailing edge facing downstream in the airflow direction, wherein the trailing edge provides an aerodynamic step extending substantially perpendicular to the airflow direction and the step is arranged to create a shadow region immediately downstream of the projection where water droplets cannot impinge on the exterior surface.

3. An aircraft according to claim 2, wherein each step is arranged to create a region of separated flow over the exterior surface immediately downstream of the projection.

4. An aircraft having an exterior surface arranged to face upstream in the airflow direction during flight, the exterior surface having a water run-back region within which impinged water droplets can flow over the exterior surface, and a plurality of anti-ice accretion projections extending away from the exterior surface from within the water run-back region, each anti-ice accretion projection having a leading edge facing upstream in the airflow direction and a trailing edge facing downstream in the airflow direction, wherein the trailing edge provides an aerodynamic step extending substantially perpendicular to the airflow direction and the step is arranged to create a region of separated air flow over the exterior surface immediately downstream of the projection for dispersing water droplets flowing over the exterior surface.

5. An aircraft according to claim 4, wherein each step is arranged to create a shadow region immediately downstream of the projection where water droplets cannot impinge on the exterior surface.

6. An aircraft according to claim 1, wherein each step has a height of 3 mm or more above the exterior surface.

7. An aircraft having an exterior surface arranged to face upstream in the airflow direction during flight and a plurality of anti-ice accretion projections extending away from the exterior surface, each anti-ice accretion projection having a leading edge facing upstream in the airflow direction and a trailing edge facing downstream of the airflow direction, wherein the trailing edge provides an aerodynamic step extending substantially perpendicular to the airflow over the exterior surface, the step having a height of 3 mm or more above the exterior surface.

8. An aircraft according to claim 7, wherein the height is 5 mm or more.

9. An aircraft according to claim 1, including an ice protection system arranged to dislodge ice accumulated within an ice protection zone of the exterior surface, the plurality of projections being located downstream of the ice protection zone.

10. An aircraft according to claim 1, wherein an intersection between the trailing edge step of each anti-ice accretion projection and the exterior surface downstream of the projection forms an angle of 150 degrees or less, preferably 135 degrees or less.

11. An aircraft according to claim 1, wherein the plurality of anti-ice accretion projections are not heated.

12. An aircraft according to claim 1, wherein each anti-ice accretion projection is movable between an extended position in which the trailing edge provides the aerodynamic step and a retracted position in which the trailing edge is substantially flush with the exterior surface.

13. An aircraft according to claim 1, wherein each anti-ice accretion projection has a ramp configuration.

14. An aircraft according to claim 1, wherein each anti-ice accretion projection has an aerodynamic surface extending between the leading edge and the trailing edge, the distance between the aerodynamic surface and the exterior surface increasing continuously from the leading edge to the trailing edge.

15. An aircraft according to claim 1, wherein the exterior surface includes a pair of exterior panels separated by a panel boundary, and the trailing edge of at least one of the projections is formed by an edge of one of the pair of exterior panels at the panel boundary.

16. An aircraft according to claim 1, wherein the exterior surface comprises an exterior surface of a nose cone, fuselage, wing, vertical tail plane, or horizontal tail plane of the aircraft.

17. An aircraft according to claim 1, wherein each projection has a pair of sides which become progressively closer to each other as they extend from the trailing edge to the leading edge.

18. An aircraft according to claim 1, further comprising channels between the projections, wherein the projections are arranged so that water droplets are driven by the airflow through the channels between the projections.

19. A method of preventing ice accretion on an exterior surface of an aircraft facing upstream in the airflow direction during flight, the method including the steps of:
a) providing a plurality of anti-ice accretion projections extending away from the exterior surface; and:
b) creating a shadow region immediately downstream of each projection where water droplets carried in the airflow cannot impinge on the exterior surface; and/or
c) creating a region of separated flow over the exterior surface immediately downstream of each projection where water droplets flowing over the exterior surface are dispersed into the airflow.

20. A method according to claim 19, wherein in step (a) each anti-ice accretion projection is provided within a super-cooled large droplet (SLD) impingement region within which super-cooled large droplets (SLD) of water can impinge on the exterior surface, and step (b) is carried out.

21. A method according to claim 19, wherein in step (a) each anti-ice accretion projection is provided within a water run-back region within which impinged water droplets can flow over the exterior surface, and step (c) is carried out.

22. A method according to claim 19, including the step of retracting each anti-ice accretion projection during high altitude cruise conditions so that it is substantially flush with the exterior surface.

23. A method according to claim 19, wherein step (a) includes providing a plurality of anti-ice accretion projections, each having a leading edge facing upstream in the airflow direction and a trailing edge facing downstream of the airflow direction, the trailing edge providing an aerodynamic step extending substantially perpendicular to the airflow over the exterior surface, and the step creating the shadow region and/or region of separated flow.

24. A method according to claim 19, wherein step (a) includes providing at least one of the projections at a boundary between exterior panels of the aircraft.

25. A method according to claim 19, wherein each projection diverts water droplets into channels between the projections.

26. A method according to claim 19, wherein each projection has a pair of sides which become progressively closer to each other as they extend from the trailing edge to the leading edge and divert water droplets into channels between the projections.
